(19) United States
(12) Patent Application Publication
(10) Pub. No.: US 2012/0253030 A1
(43) Pub. Date: Oct. 4, 2012

(54) PROCESS FOR MANUFACTURING LOW-FIBRILLATING CELLULOSIC FIBER

(75) Inventors: Bir KAPOOR, Mumbai (IN); Preeti LODHA, Mumbai (IN); Parag PATIL, Mumbai (IN); Aditya SHRIVASTAVA, Nagda (IN); Kishore SHOUCHE, Nagda (IN); Eric UERDINGEN, Speyer (DE); Michael SIEMER, Mannheim (DE); Thomas WISNIEWSKI, Bensheim (DE); Uwe VAGT, Mannheim (DE); Massonne KLEMENS, Bad Durkheim (DE)

(73) Assignee: GRASIM INDUSTRIES LIMITED, Nagda (IN)

(21) Appl. No.: 13/440,076

(22) Filed: Apr. 5, 2012

Related U.S. Application Data
(63) Continuation of application No. PCT/IN2010/000659, filed on Oct. 5, 2010.

(30) Foreign Application Priority Data
Oct. 7, 2009 (IN) 2333/MUM/2009

(51) Int. Cl. B29C 47/30; C08B 1/00

(52) U.S. Cl. 536/56; 264/13

(57) ABSTRACT

A process for manufacturing low-fibrillating cellulosic fibers by a dry-jet-wet spinning process is provided. The cellulose is treated with a specific ionic liquid based solvent to produce the said fibers with fibrillating index less than or equal to (3).

### CROSS-REFERENCE TO RELATED APPLICATIONS

This application is a continuation of International Application No. PCT/IN2010/000659, filed Oct. 5, 2010. This application claims priority to Indian Application No. 2333/MUM/2009, filed Oct. 7, 2009. The disclosure(s) of the above applications are incorporated herein by reference.

### FIELD

The disclosure relates to a process for preparing non-fibrillating cellulosic fibers and cellulosic fibers prepared by the process.

### DEFINITIONS

The term “Viscose Process” is a process used for the preparation of man-made cellulose fibers made from cellulose which involves the use of solvents such as sodium hydroxide (an alkali), carbon disulfide and acid solution, and wet spinning of the fibers.

The term Lyocell Process is the process for manufacturing of cellulose fibers which involve the use of direct solvents such as N-methyl Morpoholine Oxide (NMMO) to dissolve the cellulose and dry-jet-wet spinning of the fibers.

The term “Wet Spinning Process” in the context of the present disclosure is a process which involves spinning of the polymer dope directly into a liquid bath.

The term “Dry-Jet-Wet Spinning” in the context of the present disclosure is a spinning process which involves spinning of the polymer dope through an air gap into a liquid bath.

The term “Ionic Liquids” refer to salts that are stable liquids having extremely low-saturated vapor pressures and good thermal stability.

### BACKGROUND

Cellulosic fibers such as cotton, rayon and lyocell are used in the manufacture of textiles and non-woven.

The conventional method for the commercial preparation of cellulosic fibers is the viscose process. In one of the conventional processes for the manufacture of cellulosic fibers, cellulose prepared from either wood pulp, is treated with sodium hydroxide and then with carbon disulfide to form cellulose xanthate.

The cellulose xanthate thus formed is dissolved in dilute solution of sodium hydroxide to obtain a thick solution called viscose. The viscose is then forced through tiny openings in a spinneret into an acid solution, which coagulates it in the form of fine strands of fibers. In the wet spinning method, the process involves spinning of polymer dope directly into a liquid bath. The cellulosic fibers obtained from the viscose process are non-fibrillating, but possess low strength. Further, the viscose process involves the use of hazardous liquids such as carbon disulfide and sulphuric acid thus making entire process not environment friendly.

In another conventional process for manufacturing cellulosic fibers, cellulose is dissolved in a cupramonium solution to form a solution which is forced through submerged spinnerets into a dilute solution of sulphuric acid, which acts as coagulating agent, to form fibers. The main drawback of the process is that efficient ammonia recovery is difficult to achieve and the process is more expensive than the viscose rayon process.

The cellulose/lyocell fibers are also known to be obtained using a dry jet wet spinning technique using N-methylmorpholine N-oxide hydrate. Although, the dry jet wet spinning process gives significantly higher fiber tenacity and modulus than the conventional wet jet spinning process, the use of N MO is not desirable due to the fact that NMMO is thermally unstable and is explosive at higher temperature leading to its degradation and generation of coloured compounds that affects the whiteness of the fibers and increasing the cost of the fiber and the fiber prepared from the above process show high fibrillation tendency, which affects the appearance of the product made from such fibers. Further, to reduce the fibrillation tendency, the conventional fibers are required to be further processed by cross-linking agents or by mechanical, chemical or enzymatic means which further add to the cost of the overall process.

WO 2009/062723 of BASF published on May 22, 2009, relates to a spinning process and discloses use of EMIM octanoate and imidazolium-dialkylphosphates.

WO 2006/000197 and WO 2007/128268 of TITK disclose a spinning process of cellulose in ionic liquid.

WO 2008/133269 of Nisshinbo Industries discloses ionic liquids, wherein the cation (including imidazolium) has at least one alkoxyalkyl group and the anion is dimethyl phosphate and has good solubility of cellulose and fibers are mentioned without any details or examples.

WO2007/076979 of BASF discloses a solution system for biopolymers in the form of carbohydrates, solution system containing molten ionic liquid, also additives optionally being contained in the solution system, is described. This solution system contains a protic solvent or a mixture of several protic solvents, and in the case where the protic solvent is solely water, it is present in the solution system in an amount of more than about 5 wt. %. The patent provides a process for regenerated cellulose non-fibrillating spun fibers.

There is, therefore, a need to develop a process, for preparing non-fibrillating cellulosic fibers, which is simple, cost effective, environment friendly and which can overcome the shortcomings of the conventional processes without requiring the use of harmful solvents. The current disclosure describes a process of manufacturing low fibrillating cellulosic fibers using dry-jet-wet spinning under specific spinning conditions using ionic liquids as solvents for cellulose.

### OBJECTS

Some of the non-limiting objects of the present disclosure, which at least one embodiment herein satisfy, are as follows:

It is an object of the disclosure to provide a process for preparing non-fibrillating cellulosic fibers which is simple, efficient and cost effective.

It is another object of the disclosure to provide a process for preparing non-fibrillating cellulosic fibers which is environment friendly.

It is another object of the disclosure to provide a process for preparing non-fibrillating fibers which provides cellulosic fibers with high strength and elongation properties.

It is further object of the disclosure to provide a process for preparing non-fibrillating cellulosic fibers which employ the solvents which withstand high temperatures and do not result in the formation of degraded products at higher temperatures.

It is a further object of the disclosure to provide a process for preparing non-fibrillating cellulosic fibers which employ solvents that can be recycled and reused.

It is still further object of the disclosure to provide a process for preparing non-fibrillating cellulosic fibers by dry-jet-wet spinning technique.

### SUMMARY

Accordingly, the disclosure provides a process for producing low fibrillating cellulose fibers by a dry-jet-wet spinning process comprising following steps: a. dissolving cellulose in a solvent system containing at least 50% by weight of at least one ionic liquid to form a polymer solution of 100 to 1000000 Poise zero shear viscosity wherein the ionic liquid has cations with heterocyclic ring system containing one or two nitrogen atoms, with each such nitrogen atom substituted by an alkyl group having 1 to 20 carbon atoms and anions being at least one selected from the group consisting of a carboxylate anion of formula Ra-COO⁻ wherein Ra is a alkyl group having 1 to 20 carbon atoms, preferably 7 to 9 carbon atoms, and phosphate anion of formula Rb-Rc-P0₄⁻, Rb and Rc are alkyl groups having 1 to 20 carbon atoms, preferably having 1 to 5 carbon atoms, and that total number of carbon atoms in the alkyl groups in the anion and cation being at least 5, preferably at least 7, most preferably at least 9;

b. spinning fibres from said solution in a spinneret through an air gap of 2 mm to 50 mm into a coagulation bath comprising 0.01% to 60% of said ionic liquid, maintained at a temperature between −50° C. to 60° C.; and
c. washing and drying the fibers obtained in step (b).

Typically, the concentration of the ionic liquid is at least 70% by weight of the solvent system.

Typically, the ionic liquid is a 1,3-disubstituted imidazolium salt of the formula I

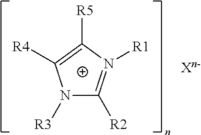

where
R1 and R3 are each, independently of one another, an organic group having 1 to 20 carbon atoms;
R2, R4 and R5 are each, independently of one another, an H atom or an organic group having from 1 to 20 carbon atoms;
X is an anion, being at least one selected from the group consisting of carboxylate anion of formula Ra-COO⁻, wherein Ra is alkyl group having 1 to 20 carbon atoms, preferably Ra is an alkyl group having 6 to 9 carbon atom, and phosphate anion of formula Rb-Rc-P0₄⁻, wherein Ra and Rb are alkyl groups having 1 to 20 carbon atoms, preferably having 1 to 5 carbon atoms, and n is 1, 2 or 3.

The total number of carbon atoms in the alkyl groups of the anion and cation being at the most 30, preferably below 26, most preferably below 22.

Typically, X is diethyl phosphate.

The solvent system further comprises at least one solvent selected from the group consisting of water, dimethyl sulfoxide, dimethyl acetamide, dimethyl formamide, N-methylpyrrolidone and mixtures thereof.

The coagulation bath further comprises at least 40% by weight of a protic solvent selected from the group consisting of water, methanol, ethanol, glycerol, n-propanol, iso-propanol and mixtures thereof.

In preferred embodiment of the present disclosure, the ionic liquid is at least one selected from the group consisting of Dibutyl imidazolium acetate, Dipentyl imidazolium acetate, Dihexyl imidazolium acetate, Dibutyl imidazolium octanoate, 1-Ethyl-3-methylimidazolium heptanoate, Dipropyl imidazolium octanoate, 1-Ethyl-3-methyl imidazolium octanoate, 1-Ethyl-3-methyl imidazolium nonanoate, 1-Ethyl-3-methyl imidazolium decanoate, 1-Ethyl-3-methyl imidazolium undecanoate, 1-Ethyl-3-methyl imidazolium dodecanoate, 1-Ethyl-3-methyl immidazolium diethyl phosphate, Diethyl imidazolium octanoate, and 1-Decyl-3-methyl imidazolium acetate.

Typically, the fibres produced in accordance with the present disclosure have fibrillation index less than or equal to 3.

### DETAILED DESCRIPTION

A process for producing a low fibrillating cellulosic fiber involves treating cellulose with a solvent system, the solvent system contains at least one ionic liquid, such that the cellulose is soluble in the solvent system to form a polymer solution, wherein concentration of cellulose in the polymer solution is in the range of 6% to 20%, spinning the polymer solution through an air gap into a coagulation bath. The coagulation bath contains a solvent containing up to 70% of ionic liquid. The coagulation bath is maintained at a temperature range of −5° C. to 60° C. The fibers emerging from the spinneret are contacted with air or an inert gas. The distance of air gap between the spinneret and coagulation bath is in the range of 2 mm to 150 mm and absolute humidity in the air is <75 g/cubic meter. The temperature of the air gap is maintained in the range of −5° C. to 50° C. The solvent system further comprises at least one solvent selected from the group consisting of water, dimethyl sulfoxide, dimethyl acetamide, dimethyl formamide, N-methylpyrrolidone and mixtures thereof.

The coagulation bath further comprises at least 30% by weight of a protic solvent selected from the group consisting of water, methanol, ethanol, glycerol, n-propanol, iso-propanol and mixtures thereof.

In preferred embodiment of the present disclosure, the ionic liquid comprises a cation with a heterocyclic ring system containing at least one nitrogen atom, such as but not limited to imidazolium, pyridinium, pyrazolium, wherein each nitrogen atom is substituted by a C]-C₂o alkyl group and the total number of carbon atoms in the alkyl groups in the cation and the anion is at least 5. The total number of carbon atoms in the alkyl groups of the anion and cation being at the most 30, preferably at the most 26, more preferably at the most 22.

The ionic liquid has a general formula I

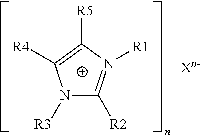

R1 and R3 are each, independently of one another, an organic molecule having 1 to 20 carbon atoms;
R2, R4 and R5 are each, independently of one another, an H atom or an organic molecule having from 1 to 20 carbon atoms;
X is an anion
n is 1, 2 or 3

Preferably, the ionic liquid is a 1,3-di substituted imidazolium salt wherein the anion in the ionic liquid is at least one selected from the group consisting of a carboxylate anion of formula Rₐ—COO⁻ wherein Rₐ is a alkyl group containing 1 to 20 carbon atoms, preferably 6 to 12 carbon atoms and dialkyl phosphate anion of formula Rb-Rc-P0₄⁻ wherein Ra and Rb are alkyl groups containing 1 to 20 carbon atoms, preferably Rb and Rc are alkyl groups independently containing 1-5 carbon atoms.

The total number of carbon atoms in the alkyl groups in the cation and the anion is at least 5. The total number of carbon atoms in the alkyl groups of the anion and cation being at the most 30, preferably at the most 22.

In preferred embodiment, the anion is diethyl phosphate.

In preferred embodiment of the present disclosure the ionic liquid is selected from a group consisting of Dibutyl imidazolium acetate, Dipentyl imidazolium acetate, Dihexyl imidazolium acetate, Dibutyl imidazolium octanoate, 1-Ethy 1-3-methyl imidazolium heptanoate, Dipropyl imidazolium octanoate, 1-Ethyl-3-methyl imidazolium octanoate, 1-Ethyl-3-methyl imidazolium nonanoate, l-Ethyl-3-methyl imidazolium decanoate, 1-Ethyl-3-methyl imidazolium undecanoate, 1-Ethyl-3-methyl imidazolium dodecanoate, 1-Ethyl-3-methyl immidazolium diethyl phosphate, Diethyl imidazolium octanoate, and 1-Decyl-3-methyl imidazolium acetate.

The cellulosic fibers prepared in accordance with the present disclosure are low fibrillating fibers.

### EXAMPLES

Cellulose was dissolved in specific ionic liquid (as given in table 1) to form a 12% polymer solution and spun from a 60 micron hole spinneret through an air gap (as given in the table 1) into a coagulation bath of specific ionic liquid concentration (as given in table 1) maintained at a set temperature (as given in table 1) to form a fiber. The denier and fibrillation property of the fiber was measured. TC in Table 1 is the total number of carbon atoms in the alkyl groups of the anion and cation of the ionic liquid in the solvent system.

TABLE 1
Spinning Experiments Details including Solvent, Spinning
Parameters and Fiber Properties

| | | | Zero Shear | | Solvent | Bath temp, | | |
|---|---|---|---|---|---|---|---|---|
| | Specific Ionic | | Viscosity, | Air Gap, | % in | Degree | Fiber | |
| SN | Liquid | TC | Posise | mm | bath | Celcius | Denier | Fibrillation |
| 1 | 1-Ethyl-3-methyl | 10 | 10000 | 2 | 20 | 30 | 1.2 | Low |
| | imidazolium | | | | | | | |
| | octanoate, | | | | | | | |
| 2 | 1-Ethyl-3-methyl | 10 | 10000 | 10 | 20 | 30 | 1.2 | Low |
| | imidazolium | | | | | | | |
| | octanoate, | | | | | | | |
| 3 | 1-Ethyl-3-methyl | 10 | 10000 | 10 | 0 | 30 | 1.2 | Low |
| | imidazolium | | | | | | | |
| | octanoate, | | | | | | | |
| 4 | 1-Ethyl-3-methyl | 10 | 10000 | 10 | 50 | −5 | 1.2 | Low |
| | imidazolium | | | | | | | |
| | octanoate, | | | | | | | |
| 5 | 1-Ethyl-3-methyl | 10 | 10000 | 10 | 30 | 5 | 1.2 | Low |
| | imidazolium | | | | | | | |
| | Octanoate, | | | | | | | |
| 6 | 1-Ethyl-3-methyl | 10 | 10000 | 50 | 50 | 20 | 1.2 | Low |
| | imidazolium | | | | | | | |
| | Octanoate, | | | | | | | |
| 7 | 1-Ethyl-3-methyl | 9 | 10000 | 10 | 10 | 30 | 1.2 | Low |
| | imidazolium | | | | | | | |
| | Heptanoate | | | | | | | |
| 8 | 1-Ethyl-3-methyl | 7 | 15000 | 10 | 10 | 30 | 1.2 | Low |
| | immidazolium | | | | | | | |
| | diethyl phosphate | | | | | | | |
| 9 | 1-Ethyl-3-Ethyl | 11 | 2000 | 10 | 10 | 30 | 1.2 | Low |
| | Imidazolium | | | | | | | |
| | Octanoate | | | | | | | |
| 10 | 1-Propyl-3-Propyl | 13 | 25000 | 10 | 10 | 30 | 1.2 | Low |
| | Imidazolium | | | | | | | |
| | Octanoate | | | | | | | |
| 11 | 1-Decyl-3-Methyl | 12 | 10000 | 10 | 10 | 30 | 1.2 | Low |
| | Imidazolium | | | | | | | |
| | Acetate | | | | | | | |
| 12 | 1-Ethyl 3-Methyl | 4 | 1000 | 10 | 10 | 50 | 1.2 | High |
| | Imidazolium | | | | | | | |
| 13 | 1-Ethyl 3-Mehyl | 4 | 1000 | 10 | 10 | 30 | 1.2 | High |
| | Imidazolium | | | | | | | |
| 14 | 1-Ethyl 3-Methyl | 4 | 1000 | 10 | 10 | −5 | 1.2 | High |
| | Imidazolium | | | | | | | |
| | Acetate | | | | | | | |

Fibrillation:

Take about 0.003 g of 20 mm long cut fibers with 5 ml distilled water in a polypropylene test tube of 1.5 cm inner diameter and 10 cm tube height. Install the tube on a shaker and subject the fiber to 80 Hz and 12 cm amplitude for 90 minutes. Place the treated fiber on a glass slide and observe under the microscope. Fibrillation index is the number of fibrils observed on a 100 micron fiber length using an optical microscope. Fibrillation index of greater than 3 is high fibrillating and equal to or less than 3 is low fibrillating.

### TECHNICAL ADVANCEMENT

The process in accordance with the present disclosure results in the formation of cellulosic spun fibers which are non-fibrillating and are used in various applications such as textiles and non-woven. The ionic liquids used in the process of the disclosure can be recovered and reused, thus making overall process efficient and economical. The process of present disclosure does not generate harmful waste products and is, therefore, environment friendly.

While considerable emphasis has been placed herein on the particular features of the preferred embodiment and the improvisation with regards to it, it will be appreciated that various modifications can be made in the preferred embodiments without departing from the principles of the disclosure. These and the other modifications in the nature of the disclosure will be apparent to those skilled in the art from disclosure herein, whereby it is to be distinctly understood that the foregoing descriptive matter is to interpreted merely as illustrative of the disclosure and not as a limitation.

What is claimed is:

1. A process for producing low fibrillating cellulose fibers by a dry-jet-wet spinning process comprising following steps:
a. dissolving cellulose in a solvent system containing at least 50% of at least one ionic liquid to form a polymer solution of 100 to 1000000 Poise zero shear viscosity wherein the ionic liquid has cations with heterocyclic ring system containing one or two nitrogen atoms, each such nitrogen atom substituted by an alkyl group having 1 to 20 carbon atoms, and anions being at least one selected from the group consisting of a carboxylate anion of formula Ra-COO⁻ wherein Ra is a alkyl group having 1 to 20 carbon atoms, preferably 5 to 0.9 carbon atoms, and phosphate anion of formula Rb-Rc-P0₄⁻, Rb and Rc are alkyl groups having 1 to 20 carbon atoms, preferably having 1 to 5 carbon atoms, and total number of carbon atoms i the alkyl groups in the anion and cation being at least 5, preferably 7, most preferably at least 9;
b. spinning fibres from said solution in a spinneret through an air gap of 2 mm to 50 mm into a coagulation bath comprising 0.01% to 70% by weight of said ionic liquid, maintained at a temperature between −5° C. to 60° C.; and
c. washing and drying the fibers obtained in step (b).

2. The process as claimed in claim 1, wherein the ionic liquid is at least one selected from the group consisting of Dibutyl imidazolium acetate, Dipentyl imidazolium acetate, Dihexyl imidazolium acetate, Dibutyl imidazolium octanoate, 1-Ethyl-3-methyl imidazolium heptanoate, Dipropyl imidazolium octanoate, 1-Ethyl-3-methyl imidazolium octanoate, 1-Ethyl-3-methyl imidazolium nonanoate, 1-Ethy 1-3-methyl imidazolium decanoate, 1-Ethyl-3-methyl imidazolium undecanoate, 1-Ethyl-3-methyl imidazolium dodecanoate, 1-Ethyl-3-methyl immidazolium diethyl phosphate, Diethyl imidazolium octanoate and 1-Decy-1-3-methyl imidazolium acetate.

3. The process as claimed in claim 1, where in the total number of carbon atoms in the alkyl groups of the anion and cation being at the most 30, preferably below 26, most preferably below 22.

4. The process as claimed in claim 1, wherein the concentration of the ionic liquid is at least 70% by weight of the solvent system.

5. The process as claimed in claim 1, wherein the solvent system further comprises at least one solvent selected from the group consisting of water, dimethyl sulfoxide, dimethyl acetamide, dimethyl formamide, N-methylpyrrolidone and mixtures thereof.

6. The process as claimed in claim 1, wherein the coagulation bath further comprises at least 40% by weight of a protic solvent selected from the group consisting of water, methanol, ethanol, glycerol, n-propanol, iso-propanol and mixtures thereof.

7. The process for producing low fibrillating cellulose fibers by a dry-jet-wet spinning process comprising following steps:
a. dissolving cellulose in a solvent system containing at least 50% of at least one 1,3-disubstituted imidazolium salt of the formula I 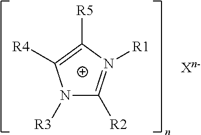
where,
R1 and R3 are each, independently of one another, an organic group having 1 to 20 carbon atoms, preferably 1 to 4 carbon atoms;
R2, R4 and R5 are each, independently of one another, an H atom or an organic group having from 1 to 20 carbon atoms, preferably R2, R4 and R5 are each H atom;
X is an anion, anion being at least one selected from the group consisting of a carboxylate anion of formula Ra-COO⁻ wherein Ra is a alkyl group having 1 to 20 carbon atoms, preferably 5 to 9 carbon atoms and phosphate anion of formula Rb-Rc-P0₄⁻, Rb and Rc are alkyl groups having 1 to 20 carbon atoms, preferably having 1 to 5 carbon atoms; and n is 1, 2 or 3 to form a polymer solution of 100 to 1000000 Poise zero shear viscosity wherein the ionic liquid has cations with heterocyclic ring system containing one or two nitrogen atoms, each such nitrogen atom substituted by an alkyl group having 1 to 20 carbon atoms, and anions being at least one selected from the group consisting of a carboxylate anion of formula Ra-COO⁻ wherein Ra is an alkyl group having 1 to 20 carbon atoms, preferably 5 to 9 carbon atoms, and phosphate anion of formula Rb-Rc-PO₄⁻, Rb and Rc are alkyl groups having 1 to 20 carbon atoms, preferably having 1 to 5 carbon atoms, and total number of carbon atoms i the alkyl groups in the anion and cation being at least 5, preferably 7, most preferably at least 9;
b. spinning fibres from said solution in a spinneret through an air gap of 2 mm to 50 mm into a coagulation bath comprising 0.01% to 70% by weight of said ionic liquid, maintained at a temperature between −5° C. to 60° C.; and
c. washing and drying the fibers obtained in step (b).

8. The process as claimed in claim 7, wherein R1 and R3 are same.

9. The process as claimed in claim 7, wherein X is diethyl phosphate.

10. The fibres produced in accordance with the claim 1 having fibrillation index less than or equal to 3.

11. The fibers produced in accordance with claim 7 having fibrillation index less than or equal to 3.
